(19) United States
(12) Patent Application Publication
(10) Pub. No.: US 2009/0205846 A1
(43) Pub. Date: Aug. 20, 2009

(54) FIRE SUPPRESSION SYSTEM FOR AN ONBOARD ELECTRICAL ENERGY SOURCE

(75) Inventors: Robert E. ZEWEKE, Shelby Township, MI (US); Gregory K. MACLEAN, Warren, MI (US)

Correspondence Address: INGRASSIA FISHER & LORENZ, P.C. (GM), 7010 E. COCHISE ROAD, SCOTTSDALE, AZ, 85253, US

(73) Assignee: GM GLOBAL TECHNOLOGY OPERATIONS, INC., DETROIT, MI (US)

(21) Appl. No.: 12/032,869

(22) Filed: Feb. 18, 2008

(51) Int. Cl. A62C 37/36; A62C 3/07

(52) U.S. Cl. 169/45; 169/60; 169/26; 169/62

(57) ABSTRACT

Methods and apparatus are provided for fire suppression in an energy storage device. The apparatus comprises an energy storage device having a housing, a first container adapted to be at least partially filled with a fire-suppressing substance, the first container in selective fluid communication with the interior of the housing, and a control system comprising a sensor, the control system adapted to place the first container in fluid communication with the interior of the housing in response to a signal from the sensor.

### TECHNICAL FIELD

The subject matter described herein generally relates to fire suppression, and more particularly relates to suppression of ignition in energy storage devices, such as batteries, capacitors, or fuel cells.

### BACKGROUND

Many hybrid electric vehicles (HEVs) and plugin hybrid electric vehicles (PHEVs) contain at least one bank of batteries which enables them to perform their functions. Typically, such banks comprise a housing containing a plurality of individual battery cells. The cells can contain any of a variety of electrochemical fluids and electrode materials which can store and provide electrical current when properly interfaced through the battery's structure.

The battery cells can contain a variety of different fluids, including some which require isolation from the external environment for proper functioning. In certain cases, such as the unavoidable impact from another vehicle, external forces can cause structural damage to a battery bank, either to its structure or the functioning of its systems. In some instances, cooling features of the battery bank can be disabled.

Some battery packs, such as those for laptops or other personal electronic equipment, can also be composed of one or more interior chambers comprising an electrochemical fluid. Although not usually prone to impacts from vehicles, certain impact events are still common occurrences, such as a dropped device. Together with other circumstances, instances can sometimes arise when the interior chambers fail to sufficiently isolate and/or cool the fluid within the appropriate chamber or cell.

Desirable features will become apparent from the subsequent detailed description and the appended claims, taken in conjunction with the accompanying drawings and the foregoing technical field and background.

### BRIEF SUMMARY

A system is provided for inhibiting ignition in an energy storage device. The system comprises an energy storage device having a housing, a first container adapted to be at least partially filled with a fire-suppressing substance, the first container in selective fluid communication with the interior of the housing, and a control system comprising a sensor, the control system adapted to place the first container in fluid communication with the interior of the housing in response to a signal from the sensor.

A method is provided for inhibiting a fire in a battery. The method comprises detecting an impact to a rigid structure comprising a battery having an interior chamber and providing a fire-suppressing substance to the interior chamber in response to detecting the impact.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### DESCRIPTION OF THE DRAWINGS

At least one embodiment of the present invention will hereinafter be described in conjunction with the following drawing figures, wherein like numerals denote like elements, and

FIG. 1 illustrates an embodiment of a fire suppression system;

FIG. 2 illustrates a schematic view of the embodiment of FIG. 1;

FIG. 3 illustrates another embodiment of a fire suppression system;

FIG. 4 illustrates a schematic view of the embodiment of FIG. 3;

FIGS. 5A and 5B illustrate an embodiment of a fire suppression system;

FIGS. 6A and 6B illustrate an embodiment of an integrated fire-suppression system; and

FIG. 7 is a schematic illustration of the steps of a process of operation of a fire suppression system.

### DESCRIPTION OF AN EXEMPLARY EMBODIMENT

The following detailed description is merely exemplary in nature and is not intended to limit the inventive subject matter or the application and uses of the inventive subject matter. Furthermore, there is no intention to be bound by any theory presented in the preceding background or the following detailed description.

Techniques and technologies may be described herein in terms of functional and/or logical block components and various processing steps. It should be appreciated that such block components may be realized by any number of hardware, software, and/or firmware components configured to perform the specified functions. For example, an embodiment of a control system, battery system or device, or a component thereof may employ various integrated circuit components, e.g., memory elements, digital signal processing elements, logic elements, look-up tables, or the like, mechanical, electromechanical, and electro-chemical devices and components and the like, which may carry out a variety of functions under the control of one or more microprocessors, mechanical switches, or other control devices. In addition, those skilled in the art will appreciate that embodiments may be practiced in conjunction with any number of data transmission protocols and that the system described herein is merely one suitable example.

Furthermore, the connecting lines shown in the various figures contained herein are intended to represent example functional relationships and/or physical couplings between the various elements. It should be noted that many alternative or additional functional relationships or physical connections may be present in an embodiment of the subject matter.

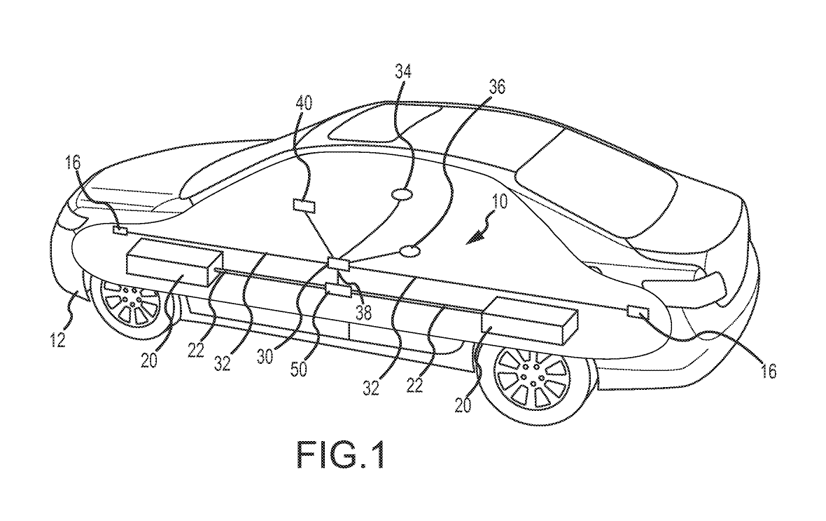

“Connected/Coupled”—The following description refers to elements or nodes or features being “connected” or “coupled” together. As used herein, unless expressly stated otherwise, “connected” means that one element/node/feature is directly joined to (or directly communicates with) another element/node/feature, and not necessarily mechanically. Likewise, unless expressly stated otherwise, “coupled” means that one element/node/feature is directly or indirectly joined to (or directly or indirectly communicates with) another element/node/feature, and not necessarily mechanically. Thus, although the schematic shown in FIG. 1 depicts one example arrangement of elements, additional intervening elements, devices, features, or components may be present in an embodiment of the depicted subject matter.

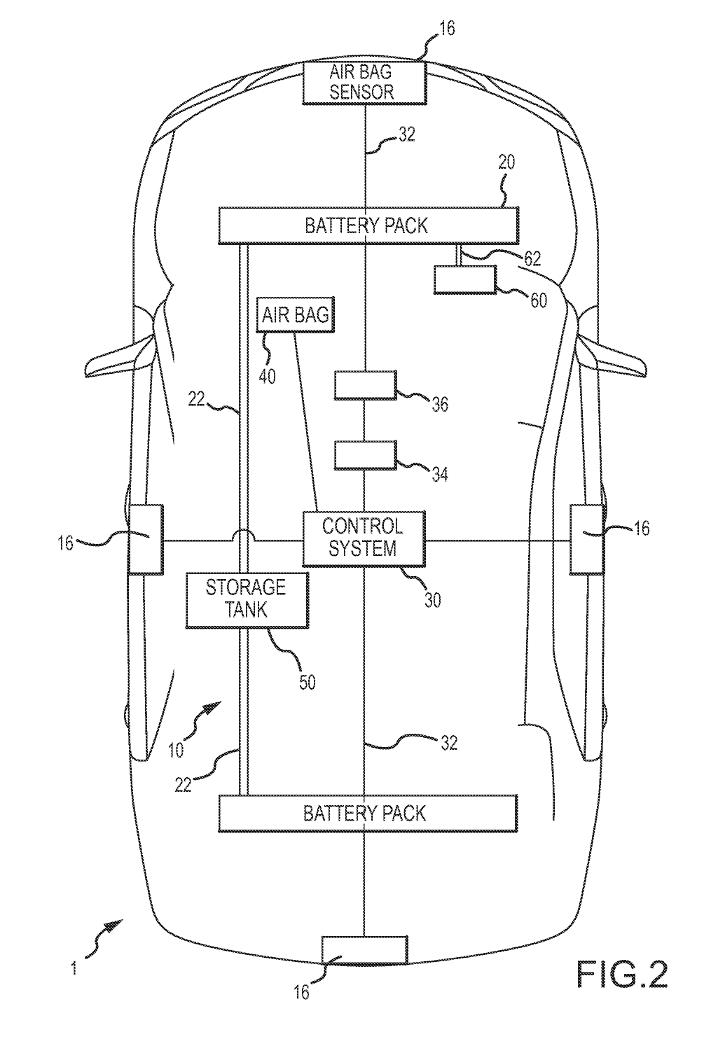

FIGS. 1 and 2 illustrate a vehicle 1 comprising a fire suppression system 10. The vehicle 1 can be a HEV, PHEV, or any other type of vehicle suitably configured with at least one battery or battery bank 20 or other energy storage device. Additionally, the fire suppression system can be embodied in other electrical-generation sources, such as fuel cells and other batteries for electronic devices. The vehicle 1 can use the battery bank 20 to provide energy for propelling the vehicle at the direction of an operator. In other vehicles, the battery bank 20 can be used for other purposes, such as providing electrical power to electronic components in the vehicle or starting an internal combustion engine.

The battery banks 20 can be a single battery component, or cell, or a plurality of separate discrete sub-batteries or sub-cell units comprising the overall bank. In some embodiments, the battery bank 20 can contain the sub-components in a housing. One embodiment of a battery bank 20 can comprise a single battery with a plurality of cells, the cells contained within a housing. Another embodiment can comprise a plurality of batteries, each further comprised of a plurality of cells, within a housing.

The vehicle 1 can comprise one or more airbag sensors 16 deployed in various locations. The airbag sensors 16 can be of any suitable type, and are typically comprised of accelerometers or sensors that monitor the structural integrity of the vehicle frame, although other sensor types can be used. The vehicle 1 can also comprise a control system 30. The control system 30 can be coupled to one or more of the airbag sensors 16 by means of a sensor wire 32. Other connection mechanisms, such as cabling, wireless communication, mechanical, or hydraulic line, can also be used.

The control system 30 can also be coupled to additional sensors, such as a pitch sensor 34 and a yaw sensor 36. The pitch and yaw sensors 34, 36 can cooperate with the control system 30 to determine the orientation of the vehicle. Typical sensors can include accelerometers, though other types can also be used. The pitch and yaw sensors 36 can be coupled to the control system through any of a plurality of mechanisms, including electrical wires.

The control system 30 can be further coupled to at least one airbag 40, of any suitable type. Some airbag systems can include one airbag disposed on the driver's side of the vehicle 1, a passenger side airbag, side-curtain airbags, and the like. The control system 30 can monitor the state of the vehicle 1 using the various sensors 16, 34, 36. In the event of a sudden impact of sufficient force, the control system 30 can deploy one or more airbags 40 for prevention of injury to the occupants of the vehicle 1.

The vehicle 1 can also comprise a fire suppression system 10. Some components of the fire suppression system can include a storage tank 50 adapted to provide a fire-suppressing substance to at least one battery bank 20 or electrical generation source. The fire suppression system 10 can be activated when a battery experiences an event which can cause it to overheat and possibly ignite into combustion. The fire suppression system 10 can cooperate with one or more components of the vehicle 1, such as the control system 30 and/or sensors 16, 34, 36. The fire suppression system 10 can comprise one or more storage tanks 50 adapted to contain a fire-suppressing substance. As shown in the embodiment illustrated in FIG. 1, the storage tank 50 can be a single unit. Other embodiments of the storage tank 50 can also exist.

The storage tank 50 can be a container or other vessel adapted to contain a substance without leakage. Some exemplary substances include fire-suppressing substances such as gaseous carbon dioxide, gaseous nitrogen, halon gases, noble gases, or other fluids, including, but not limited to, non-flammable gases and liquids, or any combination thereof. Some storage tanks can contain internal barriers which separate the storage tank into different chambers, each chamber containing a fire-suppressing substance, or a mix of different fire-suppressing substances.

The storage tank 50 can be coupled to the one or more battery bank 20 through the use of tubes or conduits 22. Each conduit 22 can extend between the storage tank 50 and a battery bank 20. As shown in the illustrated embodiment, the conduits 22 can extend to each battery bank 20 from the storage tank 50. In those embodiments where the storage tank 50 comprises discrete interior chambers, the conduits 22 can extend from a single chamber in the storage tank 50 to a battery bank 20, or each individual battery bank 20 can be coupled to a different interior chamber of the storage tank 50.

The storage tank 50 can discharge or provide the fire-suppressing substance through one or more conduits 22 as controlled by the control system 30. The control system 30 can be coupled to the storage tank 50 through a storage tank control wire 38. One or more control wires 38 can couple the control system 30 to the storage tank 50. Additionally, in those embodiments with more than one storage tank, the control system 30 can be coupled directly to each, or to one, which in turn couples to one or more of the remaining storage tanks. Similarly, the control system 30 can be coupled to one or more sensor directly, or as part of a chain to other sensors. The control system 30 can also be configured to provide a fire-suppressing substance to fewer than all the battery banks 20 in the even of activation. As one example, where two lateral battery banks exist in a vehicle, a fire-suppressing substance can be provided to one battery bank, but not the other. Other combinations can exist as well. In some embodiments, at least one storage tank 50 can be disposed within the outer housing of the battery bank 20. In certain embodiments, each battery bank 20 can have a storage tank 50 within its housing.

The conduits 22 can place the interior of the battery bank 20 in fluid communication with the interior of the storage tank 50. In some embodiments, the conduits 22 can comprise one or more valves, closeable apertures, or other selective closing mechanisms adapted to inhibit fluid communication through the conduit 22. In some embodiments, such a valve or closeable aperture can be disposed at either end of the conduit 22, such as within the storage tank 50, inhibiting flow of the fire-suppressing substance through the conduit 22.

With reference to the embodiment illustrated in FIG. 2, an optional secondary storage tank 60 can be disposed near a battery bank 20. A secondary conduit 62 can couple the secondary storage tank to the battery bank 20. In certain embodiments, the storage tank 50 or secondary storage tank 60 can be coupled to only one of several battery banks 20, participating as one of a plurality of storage tanks, each connected to one or more battery banks 20, thereby allowing for variations in proximity between storage tanks and battery tanks, correspondingly shorter or longer conduit lengths, and multiple or redundant connections, including multiply-connected conduits. As a result, one or more storage tanks can be placed in selective fluid communication, through the use of valves, gates, and the like, with one or more battery banks. The components in the schematic of the embodiment illustrated in FIG. 2 have been placed for clarity, and are not representative of specific location, scale, or interconnectedness.

The vehicle 1 can become involved in an impact while stationary or during operation. Such an impact can have a disruptive effect on the battery banks 20, including rupture of one or more electro-chemical cells thereof. In some embodiments, such as those battery banks comprising lithium ion battery components, leakage of the electrochemical portions can cause at least some of the contents of the battery banks 20 to potentially reach ignition temperatures. For ignition to occur, sufficient fuel, oxygen, and heat must be present in the battery. A fire-suppressing substance can be one which inhibits the presence of at least one of the three necessary elements. Accordingly, introduction of a fire-suppressing substance (such as one contained in the storage tank 50) to the interior of the housing of the battery bank 20 can inhibit ignition, and reduce the risk of fire.

One mechanism for detecting an impact can be the airbag sensors 16. Other sensors, such as the pitch and yaw 34, 36 sensors can also be used to detect certain conditions of the vehicle, including rollover or inverted states. In some or all of these conditions, damage to the battery banks 20 can occur. Accordingly, the control system 30 can be adapted to transfer, release, or provide the fire-suppressing substance contained within the at least one chamber of the storage tank 50 to the interior of the battery banks 20 in response to an appropriate signal. Such a signal can include one indicating an event sufficient to cause airbag deployment. By providing a fire-suppressing substance, such as gaseous carbon dioxide, ignition within the battery or battery bank can be inhibited by decreasing available oxygen for ignition.

In some embodiments, sensors within the battery banks, such as temperature sensors, can be coupled to the control system. In such embodiments, when the temperature in the battery bank exceeds a predetermined threshold, a control system can initiate introduction of the fire-suppressing substance to the interior of the battery bank. Such detection and initiation can comprise activation of the fire suppression system.

In the illustrated embodiment, activation of the fire suppression system 10 can be configured to occur at substantially the same time as airbag 40 deployment, once a sensor detects an impact to the vehicle 1 or of the vehicle 1 of sufficient magnitude. The threshold for such impact can be predetermined.

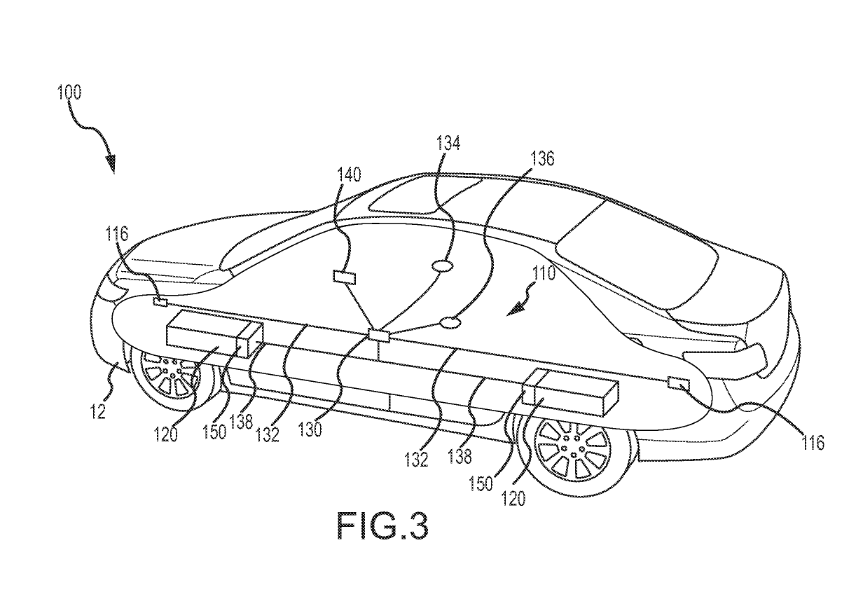

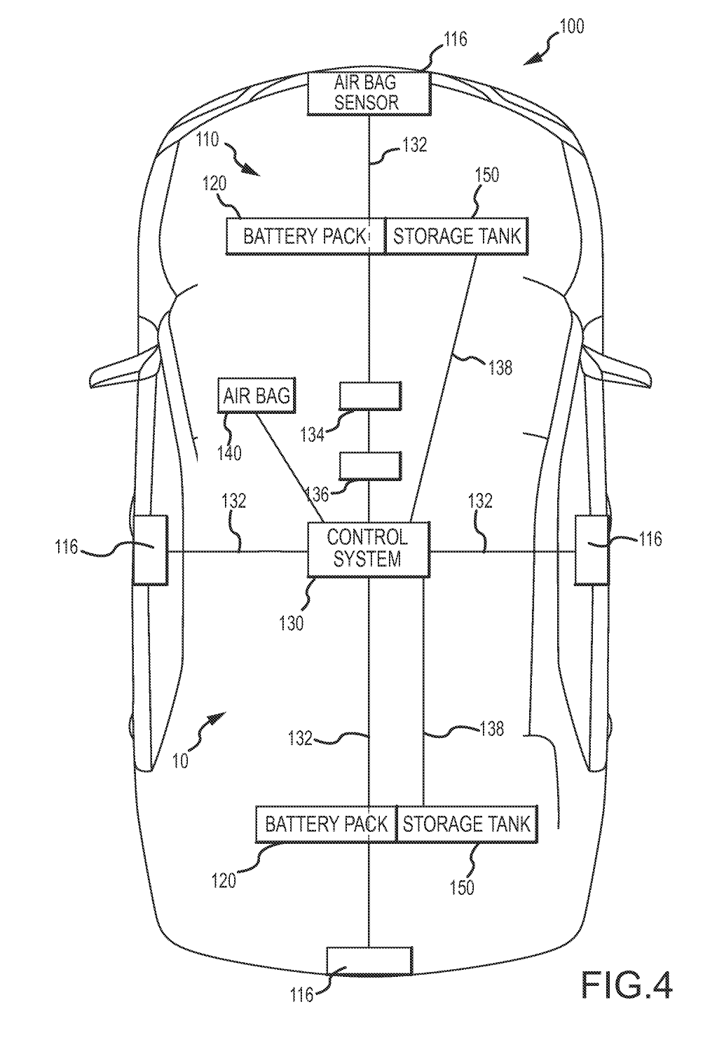

With reference to FIGS. 3 and 4, another embodiment of a vehicle is shown. Unless otherwise noted, the numerals referring to components are similar to those of FIGS. 1 and 2, except they have been incremented by 100.

In the illustrated embodiments, the storage tanks 150 are disposed immediately adjacent the battery banks 120. In some embodiments, the storage tank 150 can be integrally formed with the battery bank 120. In certain embodiments, they may be adjacent and in contact, but constructed as discrete and separate components. In some embodiments where a storage tank 150 is disposed in close proximity to a battery bank 120, the conduit between each can be eliminated. In other embodiments, conduits can extend from a storage tank adjacent a battery bank to a different battery bank. As described above, conduits can be multiply connected as well. Additionally, as shown, the control system 130 can be coupled with the storage tank 150 by way of one or more storage tank control wires 138.

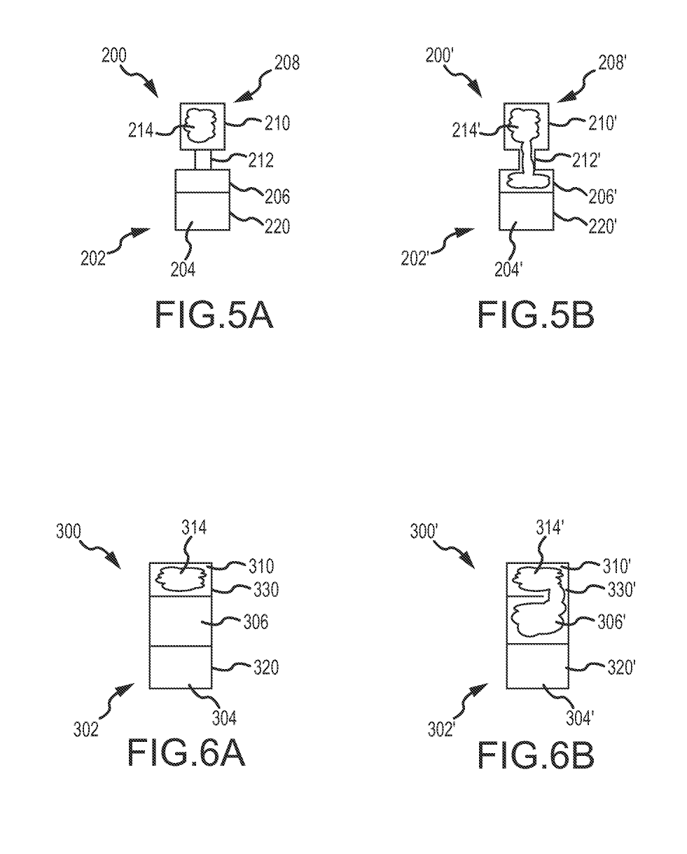

With additional reference to FIGS. 5A and 5B, one embodiment of a battery and fire suppression storage apparatus is illustrated. As one embodiment, the battery can be a battery bank 20, 120 and the storage apparatus can be a storage tank 50, 150, as described above. As an example of another embodiment, a storage tank, container, or compartment with an enclosed fire-suppressing substance can be integrally formed with a battery pack, such as a battery pack for laptop computers, cellular phones, and other electronic devices. Although airbag sensors have been described for use with the fire suppression system 10, 110, other sensors, such as temperature sensors, accelerometers, voltage and current sensors, and others suitable to detecting events leading to potential ignition in batteries, can be adapted as suitable for the device in which the fire suppression system is embodied. Such sensors can be part of a fire-suppression system embodied not only in a vehicle or the electronic devices described above, but also in any rigid structure comprising a suitable battery or set of battery components.

In some embodiments, the fire suppression system 200 illustrated in FIG. 5A comprises a battery 202 and a container 208. The battery 202 can comprise a housing 220 enclosing a cell or block of cells 204. The housing 220 can additionally comprise at least some empty space 206. The volume of the space 206 can vary in shape and volume as appropriate to the battery 202. The container 208 can comprise a housing 210 enclosing a fire-suppressing substance 214, as described above. A conduit 212 can place the battery 202 and container 208 in fluid communication. The fluid communication enabled by the conduit 212 can be selective, e.g., permitted and inhibited in different states of the system 200. In FIG. 5A, fluid communication is illustrated as inhibited by at least one of the housings 210, 220 of the battery 202 or container 208. In some embodiments, the conduit 212 can comprise a valve, seal, or other device which can be used to selectively control fluid communication. Any or all of the battery 202, container 208, and conduit 212 can be integrally formed or discrete components

FIG. 5B illustrates another state of the embodiment of the system of FIG. 5A. Accordingly, numerals identifying components are similar to those of FIG. 5A except that a prime symbol (′) has been appended. With Reference to FIG. 5B, the battery 202′ and container 208′ have been placed in fluid communication through the conduit 212′. Thus, the fire-suppressing substance 214′ has been provided from the container 208′ to the space 206′ inside the battery 202′. Preferably, ignition of an object, fluid, or other fuel in the volume enclosed by the housings 210′, 220′ is suppressed by the fire-suppression substance 214′.

Additionally, FIGS. 6A and 6B illustrate an integrated fire-suppression system 300, 300′. With reference to FIG. 6B, a battery 302 comprising one or more electro-chemical containing cells 304 and an empty space 306 of varying size and shape can be contained within a battery housing 320. Contiguous with the battery 302, a chamber 310 containing a fire-suppressing substance 314 can be constructed. The chamber 310 can be contained within a housing 330. The battery housing 320 can be formed of the same material as the chamber housing 330, or a different material. Additionally, the battery 302 can be integrally formed with the chamber 310 or they can be held in physical contact, such as by a glue or screw or other attachment mechanism.

FIG. 6B illustrates another state of the embodiment of the system of FIG. 6A. Accordingly, numerals identifying components are similar to those of FIG. 6A except that a prime symbol (′) has been appended. With Reference to FIG. 6B, the battery 302′ and chamber 318′ have been placed in fluid communication through an opening or aperture 340′. Thus, the fire-suppressing substance 314′ is present in the internal space 306′ of the battery 302′. Preferably, ignition of an object, fluid, or other fuel in the volume enclosed by the housings 210′, 220′ is suppressed by the fire-suppression substance 214′, as described above.

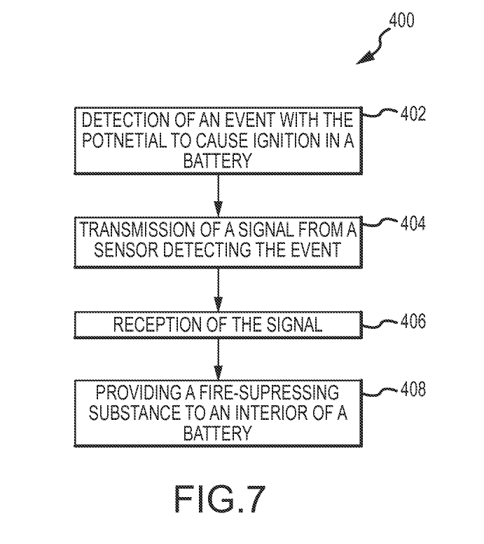

FIG. 7 illustrates a sequence 400 of steps by which a fire-suppression system can inhibit ignition in a battery.

The various tasks performed in connection with sequence 400 may be performed by software, hardware, firmware, or any combination thereof. For illustrative purposes, the following description of sequence 400 may refer to elements mentioned above in connection with FIGS. 1-6B. In practice, portions of process 400 may be performed by different elements of the described system, e.g., battery bank 20, control system 30, and/or storage tank 50. It should be appreciated that sequence 400 may include any number of additional or alternative tasks, the tasks shown in FIG. 7 need not be performed in the illustrated order, and sequence 400 may be incorporated into a more comprehensive procedure or process having additional functionality not described in detail herein.

Initially, detection 402 of an event with the potential to cause ignition in a battery can be accomplished by a suitably configured sensor, sensing architecture, or control system. As described above, one such event can be the impact of a vehicle comprising the battery at a speed sufficient to cause damage to the battery. Such an impact can occur to a stationary vehicle when struck by another vehicle or other object. Accordingly, a sensor sufficient to accomplish the detection can be an airbag sensor. In other embodiments, such as non-vehicle embodiments, an accelerometer, gyroscopic sensor, or temperature sensor, including a thermocouple, can be used.

Upon detection 402 of such an event, the sensor can effect a transmission 404 of an appropriate control or trigger signal to another component, indicating the occurrence of the event. Correspondingly, another component of the system can receive 406 the signal. Such a component could be a control system adapted to monitor one or more sensors. In other embodiments, including non-vehicle embodiments, the component could be integrated with a fire-suppressing substance storage device. In some embodiments, the fire-suppressing substance storage device can be connected to the battery through an aperture in the battery housing. In certain embodiments, the aperture can be in fluid connection with a conduit capable of providing a fire-suppressing substance from a separate container. In some embodiments, the container enclosing the fire-suppressing substance can be disposed at least partially within the housing of the battery.

Upon reception 406 of a signal, the fire-suppressing substance can be provided 408 to the interior of the battery. In some embodiments, the substance can be provided through an opening in the battery housing. In others, the substance can be provided from within the battery housing. With the introduction of the fire-suppressing substance to the interior of the battery, ignition can be inhibited by sufficiently diminishing the presence of fuel, oxygen, or heat in the battery.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A fire suppression system for use with a battery, the system comprising:
a first battery comprising a first interior chamber;
a sensor adapted to detect changes in acceleration of a structure comprising the sensor;
a first container adapted to be at least partially filled with a first fire-suppressing substance, the first container in selective fluid communication with the first interior chamber; and
a control system adapted to provide the first fire-suppressing substance from the first container to the first interior chamber in response to a signal from the sensor.

2. The fire suppression system of claim 1, wherein the sensor comprises an airbag deployment sensor.

3. The fire suppression system of claim 1, wherein the first container is coupled to the battery.

4. The fire suppression system of claim 1, further comprising a second battery, the second battery comprising a second interior chamber and the second interior chamber in selective fluid communication with the first container.

5. The fire suppression system of claim 4, wherein the control system is further adapted to provide the first fire-suppressing substance from the first container to the second interior chamber in response to the signal from the sensor.

6. The fire suppression system of claim 1, wherein the control system is further adapted to provide the fire-suppressing substance to each of the first interior chamber and the second interior chamber independent of the other chamber.

7. The fire suppression system of claim 4, further comprising a second container adapted to be at least partially filled with a second fire-suppressing substance.

8. The fire suppression system of claim 7, wherein the control system is further adapted to provide the second fire-suppressing substance from the second container to the second interior chamber in response to the signal from the sensor.

9. A method of inhibiting a fire in a battery comprising:
detecting an impact to a rigid structure comprising a battery having an interior chamber; and
providing a fire-suppressing substance to the interior chamber in response to detecting the impact.

10. The method of claim 9, wherein detecting an impact to a rigid structure comprises receiving a signal from a sensor comprising an accelerometer.

11. The method of claim 9, wherein detecting an impact to a rigid structure comprises receiving a signal from an airbag deployment sensor.

12. The method of claim 9, wherein providing the fire-suppressing substance comprises providing the substance to the interior chamber through an aperture of the interior chamber.

13. The method of claim 12, wherein providing the fire-suppressing substance comprises transporting the fire-suppressing substance through a conduit.

14. A system for inhibiting ignition in an energy storage device, the system comprising:
an energy storage device having a housing;
a first container adapted to be at least partially filled with a fire-suppressing substance, the first container in selective fluid communication with the interior of the housing; and
a control system comprising a sensor, the control system adapted to place the first container in fluid communication with the interior of the housing in response to a signal from the sensor.

15. The system of claim 14, wherein the fire-suppressing substance comprises a gas.

16. The system of claim 15, wherein the fire-suppressing substance comprises gaseous carbon dioxide.

17. The system of claim 15, wherein the fire-suppressing substance comprises gaseous nitrogen.

18. The system of claim 15, wherein the fire-suppressing substance comprises a noble gas.

19. The system of claim 14, further comprising an airbag adapted to be deployed in response to the signal from the sensor.

20. The system of claim 19, wherein the energy storage device comprises a plurality of cells.
